(19) United States
(12) Patent Application Publication
(10) Pub. No.: US 2008/0133571 A1
(43) Pub. Date: Jun. 5, 2008

(54) Modifying Behavior in Messaging Systems According to Organizational Hierarchy

(75) Inventors: Patrick J. O'Sullivan, Dublin (IE); Edith H. Stern, Yorktown Heights, NY (US); Robert C. Weir, Westford, MA (US); Barry E. Willner, Briarcliff Manor, NY (US)

Correspondence Address: CUENOT & FORSYTHE, L.L.C., 12230 FOREST HILL BLVD., STE. 120, WELLINGTON, FL, 33414, US

(73) Assignee: INTERNATIONAL BUSINESS MACHINES CORPORATION, Armonk, NY (US)

(21) Appl. No.: 11/566,718

(22) Filed: Dec. 5, 2006

(51) Int. Cl. G06F 15/16; G06F 17/30

(52) U.S. Cl. 707/102; 709/206; 707/E17.009

(57) ABSTRACT

The behavior of a messaging system can be modified. A message from a sender can be received. A determination can be made that the message is associated with a workflow. A position of the sender within an organizational hierarchy can be identified. The workflow associated with the message can be initiated according to the position of the sender.

### BACKGROUND OF THE INVENTION

Messaging systems, such as electronic mail systems, instant messaging systems, and the like, have come to be used more broadly than as originally intended. Though not particularly well suited for collaboration, for example, messaging systems are used for collaborative purposes that extend well beyond merely exchanging information. For example, messaging systems have been used for voting, controlling and/or routing work among various business units, and the like. In the typical case, one person sends a message to another person and copies additional persons. These individuals in turn respond, which results in a dramatic increase in the number of messages exchanged.

This increase in messaging does not always translate into increased efficiency or effectiveness. In fact, voluminous messaging can have the opposite effect. Many users often feel as if they are “drowning” under a deluge of electronic communications. High priority tasks delegated through messaging systems often go unfinished. An important message can easily get lost within the large number of messages a user typically receives.

In an attempt to address this problem, some messaging systems provide organizational tools that, for example, allow color coding of messages from selected senders or automatic detection and purging of unwanted messages. Despite the inclusion of these features, it still is not uncommon to hear responses such as “I didn't realize you wanted this done by today” or “I must have deleted that message” when a task goes undone.

### BRIEF SUMMARY OF THE INVENTION

The present invention relates to a method of modifying behavior of an electronic messaging system. The method can include receiving a message from a sender and determining that the message is associated with a workflow. A position of the sender within an organizational hierarchy can be identified. The workflow associated with the message can be initiated according to the position of the sender. The workflow further can be initiated according to an organizational relationship between the sender and the recipient.

The present invention also relates to a system for modifying behavior of an electronic messaging system. The system can include an organizational hierarchy specifying user positions within an organization and a messaging server including at least one workflow. The system further can include a first messaging client associated with a sender and a second messaging client associated with a recipient. The first messaging client can send a message associated with the workflow to the recipient. The workflow can be initiated according to a position of the sender within the organizational hierarchy and/or an organizational relationship between the sender and the recipient.

The present invention also relates to a computer program product including a computer-usable medium having computer-usable program code that, when executed by an information processing system, performs the various steps and/or functions described herein.

### BRIEF DESCRIPTION OF THE SEVERAL VIEWS OF THE DRAWINGS

FIG. 1 is a block diagram illustrating a system in accordance with one aspect of the present invention.

FIG. 2 is a block diagram illustrating an organizational hierarchy in accordance with another aspect of the present invention.

FIG. 3 is a flow chart illustrating a method of modifying behavior of a messaging system in accordance with another aspect of the present invention.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment, including firmware, resident software, micro-code, etc., or an embodiment combining software and hardware aspects that may all generally be referred to herein as a “circuit”, “module”, or “system”.

Furthermore, the invention may take the form of a computer program product accessible from a computer-usable or computer-readable medium providing program code for use by, or in connection with, a computer or any instruction execution system. For the purposes of this description, a computer-usable or computer-readable medium can be any apparatus that can contain, store, communicate, propagate, or transport the program for use by, or in connection with, the instruction execution system, apparatus, or device.

Any suitable computer-usable or computer-readable medium may be utilized. For example, the medium can include, but is not limited to, an electronic, magnetic, optical, electromagnetic, infrared, or semiconductor system (or apparatus or device), or a propagation medium. A non-exhaustive list of exemplary computer-readable media can include an electrical connection having one or more wires, an optical fiber, magnetic storage devices such as magnetic tape, a removable computer diskette, a portable computer diskette, a hard disk, a rigid magnetic disk, an optical storage medium, such as an optical disk including a compact disk-read only memory (CD-ROM), a compact disk-read/write (CD-R/W), or a DVD, or a semiconductor or solid state memory including, but not limited to, a random access memory (RAM), a read-only memory (ROM), or an erasable programmable read-only memory (EPROM or Flash memory).

A computer-usable or computer-readable medium further can include a transmission media such as those supporting the Internet or an intranet. Further, the computer-usable medium may include a propagated data signal with the computer-usable program code embodied therewith, either in baseband or as part of a carrier wave. The computer-usable program code may be transmitted using any appropriate medium, including but not limited to the Internet, wireline, optical fiber, cable, RF, etc.

In another aspect, the computer-usable or computer-readable medium can be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the currently available types of network adapters.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention relates to modifying behavior of a messaging system according to an organizational hierarchy. Users of a messaging system, whether electronic mail, instant messaging, or the like, can associate messages with workflows. The workflows available to a given user can depend upon the position of that user within the organizational hierarchy. When the message is received within a messaging client of a recipient, the workflow can be initiated and/or performed. The selection and/or implementation of the workflow further can depend upon the position of the recipient within the organizational hierarchy. These and other aspects of the present invention will be described with reference to the figures below.

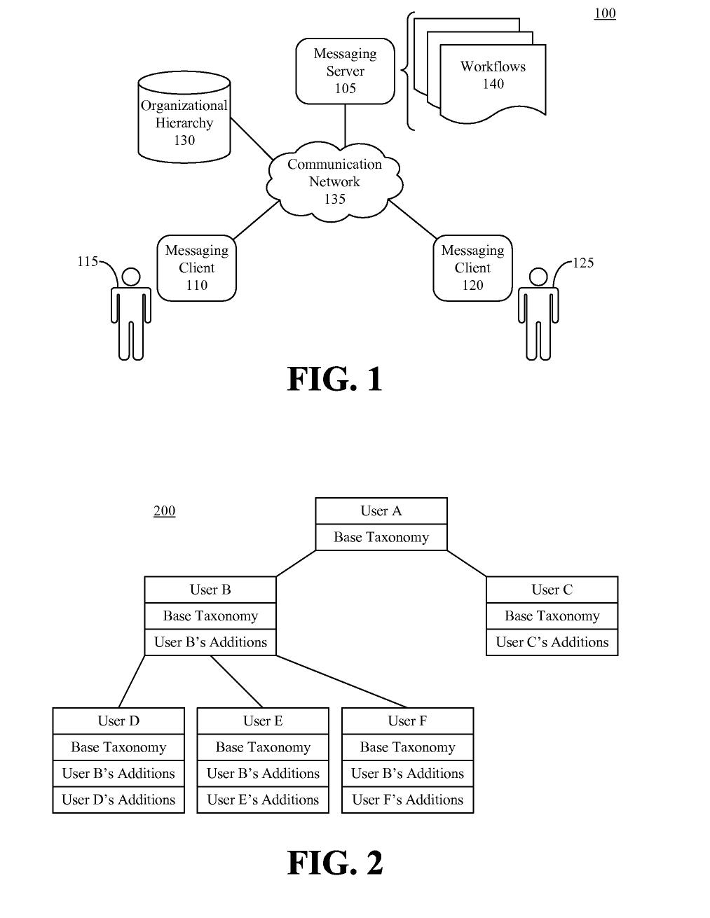

FIG. 1 is a block diagram illustrating a system 100 in accordance with one aspect of the present invention. The system 100 can include a messaging server 105, a messaging client 110 that is associated with a sender 115, and a messaging client 120 that is associated with a recipient 125. An organizational hierarchy 130 also can be included. The messaging server 105 can communicate with the messaging clients 110 and 120 to distribute messages sent amongst the messaging clients 110 and 120. In one embodiment, for example, the messaging server 105 and the messaging clients 110 and 120 can be implemented as an electronic mail server and a plurality of electronic mail clients.

The messaging server 105, the messaging clients 110 and 120, and the organizational hierarchy 130 can be communicatively linked through a communication network 135. The communication network 135 can be implemented as, or include, without limitation, a WAN, a LAN, the Public Switched Telephone Network (PSTN), the Web, the Internet, and one or more intranets. The communication network 135 further can include one or more wireless networks, whether short or long range. For example, in terms of short range wireless networks, the communication network 135 can include a local wireless network built using Bluetooth or one of the IEEE 802 wireless communication protocols, i.e., 802.11a/b/g/i, 802.15, 802.16, 802.20, Wi-Fi Protected Access (WPA), or WPA2. In terms of long range wireless networks, the communication network 135 can include a mobile, cellular, and or satellite-based wireless network and support voice, video, text, and/or any combination thereof, i.e., GSM, TDMA, CDMA, and/or WCDMA network.

The organizational hierarchy 130 can be stored within a network accessible data storage device. The organizational hierarchy 130 can specify the position of the various users, e.g., members or employees, of a given organization. As such, sender 115 and recipient 125 each can have a position within the organizational hierarchy 130. The organizational hierarchy 130 can indicate organizational distances and relationships between members of the organization. For example, the organizational hierarchy 130 can indicate which users report to which other users in an employer-employee capacity, an employee-manager capacity, an employee-supervisor capacity, that recipient 125 reports to sender 115, and/or designated roles for users.

In one embodiment, the organizational hierarchy 130 can be implemented as a Lightweight Directory Access Protocol (LDAP) directory, such as a corporate database or directory, that specifies organizational relationships among the various members of the organization. The LDAP directory, for example, can be supplemented with metadata which associates user rights with a set of capabilities. These capabilities can be linked or associated with one or more workflows 140. In another embodiment, the organizational hierarchy 130 can be derived from such a database, and implemented in the form of a directed acyclic graph. In any case, the organizational hierarchy 130 can specify user rights and/or capabilities which can be used to determine workflows 140 that are available for a user given the position of the user within the organizational hierarchy 130.

The various user rights, as specified by the organizational hierarchy 130, can be used to determine which of a plurality of workflows 140 can be accessed, or used by, the members of the organization. As shown, the workflows 140 can be stored within the messaging server 105. This allows the workflows 140 to be extended, modified, deleted, or otherwise used in a manner that does not require access to the organizational hierarchy 130, which may be unavailable for editing. Though stored in the messaging server 105, it should be appreciated that the workflows 140 also can be made available to the various messaging clients 110 and 120 offline. The workflows 140 can be synchronized between the messaging clients 110 and 120 and the messaging server 105 from time-to-time, upon startup, or periodically. In any case, storage of the workflows 140 locally within the messaging clients 110 and/or 120 allows the workflows 140 to be implemented despite the messaging clients 110 and 120 being offline.

Different ones of the workflows 140 can be made available to different users within the organizational hierarchy 130 according to position or, in some cases, an assigned role of the user which can transcend position. As used herein, a “workflow” can refer to a set of one or more tasks or actions that can be performed by any of a variety of different systems, where the systems may be software-based and/or hardware-based systems which may integrate with, or be controlled by, software. The workflows 140 can be implemented by the messaging server 105, the messaging clients 110 and/or 120, or any combination thereof. A workflow 140 can cause a messaging client, e.g., messaging client 120, or the messaging server 105 to perform one or more tasks automatically responsive to an event such as receiving a message that has been associated with a workflow.

For example, a workflow 140, when implemented, can prevent a user from performing any function within his or her messaging client until a particular message received by the messaging client, or instruction within the message, has been acted upon. Another example of a workflow 140 can include presenting a particular message received in the messaging client at the top of the message queue, e.g., at the top of one's inbox within a mail client. The message can remain atop of the queue until such time that the recipient performs some requested or required action. These workflows 140 are provided for purposes of illustration and are not intended to suggest one particular type of workflow 140 or otherwise limit the functions or tasks that can be implemented by a workflow 140. Virtually any sort of task that can be implemented within a component of a messaging system can be a workflow 140 or part of a workflow 140.

In operation, the sender 115 can initiate a message, such as an electronic mail, from messaging client 110. Through messaging client 110, sender 115 can associate the message with a workflow 140 that is available to sender 115 according to the position of sender 115 within the organizational hierarchy 130. That is, the position of sender 115 within the organizational hierarchy 130 can be associated with one or more workflows 140 that are available to the sender 115 for linking or association with messages. The available workflows 140 can be accessed via the messaging client 110 and/or the messaging server 105. Once a workflow 140 is selected by the sender 115, the workflow 140 can be associated with the message. The message can be sent to the messaging client 120 of recipient 125 via the communication network 135 and the messaging server 105.

The messaging client 120 can retrieve the message and determine that a workflow 140 has been associated with the message. The messaging client 120 can further identify or select the workflow 140 that has been associated with the message through access to the messaging server 105 and/or the organizational hierarchy 130, or from a locally stored version of the workflow 140. For example, the messaging client 120 can query the messaging server 105 for the workflow 140. In one arrangement, the message can include an indicator that uniquely identifies the workflow 140 associated with the message. The messaging client 120 can provide the indicator to the messaging server 105 and retrieve the indicated workflow 140, which then can be implemented within the messaging client 120. In another arrangement, the messaging server 105 can identify the workflow while routing the message or upon request by the messaging client 120, and then initiate the workflow 140. Still, both the messaging client 120 and the messaging server 105 can implement the workflow.

FIG. 2 is a block diagram illustrating an organizational hierarchy 200 in accordance with another aspect of the present invention. The organizational hierarchy 200 specifies a vertical taxonomy that indicates natural relationships among the members. For example, the vertical taxonomy can indicate which members report to which other members, thereby specifying the structure of the organization in terms of the positions of the members. Different workflows can be associated with different levels of the vertical taxonomy.

In one embodiment, the organizational hierarchy 200 can be implemented as an LDAP directory specifying members of an organization. While the organizational hierarchy 200 can be expressed in any of a variety of different formats, in another arrangement, the organizational hierarchy 200 can be implemented as a directed acyclic graph. A directed acyclic graph allows a primitive in one branch and a primitive in another disparate branch to overlap where the parents of each primitive collide within the tree. The users can be different as additional semantics, e.g., rights and capabilities, can be added at various levels within the organizational hierarchy 200.

As shown, at the base, or root, of the organizational hierarchy 200 is user A. User A has been associated with a base taxonomy which can be inherited by all children of user A, i.e., user B and user C, as well the children of users B and C. Accordingly, any rights and capabilities, and thus workflows, associated with the base taxonomy of user A also can be made available to users B, C, D, E, and F. Each child can inherit the taxonomy of its parent, which allows each child to further inherit workflows of the parents.

Within a given sub-tree, e.g., the sub-tree formed of users B, D, E, and F, various additions to the taxonomy can be specified. User B can inherit the taxonomy of user A, but also can add his or her own semantics, denoted as “user B's additions” to the taxonomy. The “user B's additions” can be inherited by the children of user B. For example, user B can add one or more rights or capabilities as part of “user B's additions” which become available to users D, E, and F. User B can add further constraints or tasks to workflows inherited from other users, or potentially add a workflow. Accordingly, at any level of the organizational hierarchy 200, that level has a taxonomy inherited from the parent and further includes any additions to the taxonomy made by that user.

In illustration, consider the case where user D inherits a base taxonomy with a taxonomy entry labeled “security” and another taxonomy entry labeled “compulsory organizational announcement”. Each entry can be associated with one or more defined workflows that can be associated with messages and executed when messaging clients receive a message associated with one of the workflows. In one aspect, a workflow can operate only for those individuals that report to user D as specified by the organizational hierarchy 200. The workflow associated with the message will not execute or be implemented by messaging clients of recipients that are not within the hierarchy of user B, i.e., user C. In this regard, the workflow can be implemented differently from one recipient to another, or not at all, based upon the organizational relationship between the sender and the recipient. The organizational relationship can be defined, at least in part, as the position of the sender within the organizational hierarchy 200 in relation to the position of the recipient within the organizational hierarchy 200. For example, the organizational relationship can be characterized in terms of distance in nodes, difference in levels, differences in branches, and the like.

In another example, user B can associate an available workflow with a message that causes the messaging client of the recipient to display the message at the top of the queue, or inbox, presented within the messaging client of the recipient. The workflow further can prevent the message from being deleted or prevent any other action from being performed within or by the messaging client until the action requested in the message is performed. For example, the recipient may be prevented from reading another message or responding to any other message until the requested action is performed. This behavior can be implemented by the workflow for only those recipients to which user B is allowed to apply the workflow, e.g., due to the role of user B or the position of user B within the organizational hierarchy 200 in relation to the position of the recipient.

Another example of a workflow can be one that, when implemented, enters a compulsory “to-do” and one or more reminders within the messaging client of the recipient. A workflow further can specify a time period in which the action requested by the message is to be performed before some further action is implemented by the workflow. For example, user B can receive a message from user A specifying a workflow demanding some action. User B then can “inherit” the workflow, being located beneath user A, i.e., a child. User B can add one or more tasks or functions to the inherited workflow. In illustration, if the workflow did not originally cause a “to-do” to be created, user B can add that aspect to the inherited workflow such that when associated with a message sent by user B, the inherited workflow can cause a “to-do” to be created in the messaging client of the recipient. Again, this assumes that user B has rights to impose such functionality upon the recipient according to the organizational hierarchy 200.

While inheritance can be useful, in some cases inheritance of rights is not desired. For example, it may be the case that one or more workflows are defined for use by upper level management and are not intended to be used by others in the organization located below a specified level within the organizational hierarchy 200. In that case, one or more parameters of the taxonomy that create associations with workflows can have additional parameters that indicate whether the right can be inherited. If the parameter is set to “no”, the right, and any workflow associated with such right or capability, is not available to children of that node in the organizational hierarchy 200.

In other cases, the role of a user within an organization can be used to provide that user with rights and workflows that, given the position of the user within the organizational hierarchy 200, otherwise would not be available. For example, a user can be assigned a role of team leader and, as part of that role, can be granted access to workflows that typically are reserved for higher level personnel. This allows the user to impose those workflows upon users that are above the team leader in terms of organizational hierarchy, but are members of the user's team, for instance. Without privileges afforded by the team leader role, the messaging clients and/or messaging server would prevent the workflows from being applied to individuals at a higher position within the organizational hierarchy 200 than the sender.

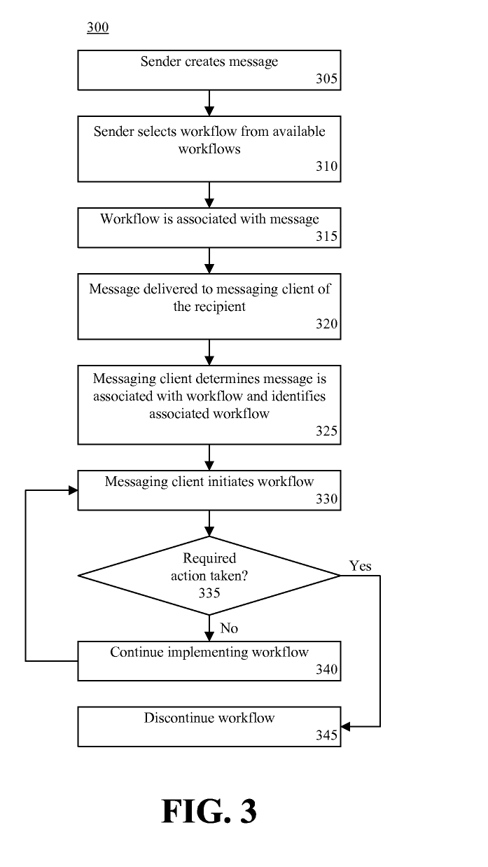

FIG. 3 is a flow chart illustrating a method 300 of modifying the behavior of a messaging system in accordance with another aspect of the present invention. The method 300 can be implemented by a system such as the system illustrated with reference to FIG. 1. In step 305, a sender can create a message from within a messaging client. In step 310, the sender can select a workflow from a set of workflows that are available to the sender based upon the location, or position, of the sender within the organizational hierarchy. The messaging client can access the workflows and determine those workflows that are available to the user based upon the position of the sender within the organizational hierarchy or an assigned role. It should be appreciated that an assigned role still can be indicated by the position of the user within the hierarchy.

In one arrangement, a workflow can be assigned to only selected recipients of the message. For example, additional user interface components can be provided as part of the message which allow the user to designate those recipients to which the workflow will apply, those recipients to be excluded from the workflow, etc. Thus, if a recipient is excluded from a workflow, when the message is received by the messaging client of the excluded recipient, the workflow will be ignored.

Similarly, it should be appreciated that different workflows can be associated with, or imposed upon, different recipients of the same message. That is, a first and a second workflow can be associated with a message where the first workflow will be imposed upon recipient A and the second workflow will be imposed upon recipient B. Such specificity with respect to associating and assigning workflows can be performed though the user interface provided by the messaging client.

As a workflow can be associated with a message and/or a particular recipient of the message, in one embodiment, the messaging client can determine whether the workflow can be imposed upon the recipient based upon the organizational relationship between the sender and the recipient. Since workflows are available according to position within the hierarchy, it may be the case that a sender associates a workflow with a message. The message can be sent to a plurality of recipients, some above the sender and some below in terms of positions within the organizational hierarchy. In one aspect, the messaging client can indicate those recipients to which a given workflow can be applied, i.e., indicate the recipients upon which the sender may impose the workflow. In another aspect, such a determination can be made within the recipient messaging client or within the messaging server.

For example, the messaging client of the sender can check the applicability of a workflow against a recipient according to the organizational relationship between the sender and recipient, e.g., whether the sender has the right to impose the workflow upon the recipient. The messaging client can inform the sender that the selected workflow cannot be applied to one of the recipients due to the position of the recipient within the organizational hierarchy, or a role that has been assigned to the recipient, as compared to the sender. In that case, the sender can be notified prior to sending the message.

As noted, the recipient messaging client can perform such a check when a message is received and selectively enforce or implement the associated workflow based upon the organizational hierarchy. For example, if the recipient is at a position below the position of the sender, or at a position that is below an assigned role of the sender, the workflow can be implemented. If above, the workflow can be ignored. Still, the messaging server can perform such a check.

Continuing, in step 315, the messaging client of the sender can associate the workflow with the message being composed. The workflow can be specified by an identifier that can be included within the message. In one aspect, the communication protocol used by the messaging system can be extended to include such an identifier. The identifier can be added so that messaging clients that participate in utilizing workflows as described herein can identify the identifier and determine that the message is associated with a workflow. Messaging clients that do not utilize workflows can ignore the identifier and process any messages associated with a workflow as any other message.

In step 320, the message can be delivered to the messaging client of the recipient, or recipients, as the case may be. In one arrangement, a message that is associated with a workflow can be presented within the recipient messaging client with an indication that the message is associated with a workflow. For example, if a sender associates a workflow relating to the security of the organizational computing network, the subject line of the message can be changed to read “SECURITY: <sender specified text here>”. The term “SECURITY” can indicate that the message is associated with a workflow relating to security. The remaining text of the subject line can be supplied by the sender. It should be appreciated that any of a variety of different visual indicators can be used to show that a message is associated with a workflow and, as such, the present invention is not intended to be limited by the use of any one type of visual indicator.

Continuing with the security example, the workflow can specify that the functionality of the messaging client is to be frozen, or otherwise unavailable, until such time that the recipient updates his or her virus protection and runs a scan of his or her computing system. Only after an indication that the action has been performed is received within the messaging client will the functionality of the messaging client be restored. For example, until the recipient indicates that the task is finished, the recipient may be unable to read further messages, receive further messages, send further messages, etc. A message can be said to be “acted upon” when an indication that a task requested by the message has been performed is received by the messaging client and/or the messaging server.

In step 325, the messaging client of the recipient can determine that the received message is associated with a workflow and identify the workflow. In one embodiment, the messaging client can query the message server with the identifier supplied within the message, the sender identity, and/or the recipient identity. As such, the messaging server, for example, can select the workflow that is associated with the message according to the indication in the message, the position of the sender within the organizational hierarchy, and/or the position of the recipient within the organizational hierarchy. It should be appreciated that using the identifier, the position of the sender and/or the position of the recipient, the messaging client, in communicating with the messaging server, can selectively implement the workflow.

In step 330, the messaging client can initiate the workflow. If action is required on the part of the messaging server, the messaging server also can initiate the workflow and work cooperatively with the messaging client. Other examples of workflows that can be implemented by the messaging clients and/or the messaging server can include, but are not limited to, automatically illuminating the message in a desired color according to organizational distance or position of a party to the message, creating automatic to-do's in the messaging client of the recipient, force intrusive reminders, escalate aggressiveness of reminders as the deadline approaches, prevent deletion of the message until requested action is performed, automatically open the message when the messaging client opens, prevent the recipient from performing any action in the client until the requested action is performed, temporarily prevent further actions from being performed in the messaging client for a minimum amount of time, e.g., 5 minutes, each time the messaging client opens, open the message associated with the workflow every 5 minutes, etc.

It should be appreciated that since the different workflows can be associated with a same message, but with different recipients of that message, different behaviors can be implemented within the various receiving messaging clients. For example, the message can be highlighted in red in one messaging client and green in another. One workflow can implement one reminder scheme, i.e., enter a “to-do”, in the messaging client of a first recipient, and a different workflow associated with the same message can implement a different reminder scheme, i.e., open the message every 5 minutes, in the messaging client of the second recipient.

In step 335, a determination can be made, for example, by the messaging client of the recipient and/or the messaging server, as to whether a required action relating to the workflow has been performed. For example, the message can require some action on the part of the recipient. The workflow may cause the messaging client to disallow any other functions from being performed within the messaging client until such time that the required action is taken by the user.

In one arrangement, the user can select a check box or some other control either within the message itself or within the messaging client to indicate that the action or task requested by the message has been performed. Upon selection of such a control, the messaging client can determine that the task has been performed. The messaging client further can provide notification to the messaging server that the recipient has performed the requisite action or task.

In any case, if the required action has been performed by the recipient, the method can proceed to step 345. If not, the method can continue to step 340. In step 340, the messaging client of the recipient and/or the messaging server can continue to implement the workflow associated with the received message. In step 345, the workflow, or execution thereof, can be discontinued.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to the embodiments thereof, it will be apparent that modifications and variations are possible without departing from the scope of the invention defined in the appended claims.

What is claimed is:

1. A method of modifying behavior of an electronic messaging system comprising:
receiving a message from a sender;
determining that the message is associated with a workflow;
identifying a position of the sender within an organizational hierarchy; and
initiating the workflow associated with the message according to the position of the sender.

2. The method of claim 1, further comprising identifying a position within the organizational hierarchy of a recipient of the message, wherein the workflow is initiated according to an organizational relationship between the sender and the recipient.

3. The method of claim 1, wherein initiating the workflow further comprises selectively applying the workflow to at least one recipient of the message.

4. The method of claim 1, wherein initiating the workflow further comprises preventing another function from being performed within the messaging client of the recipient until an indication that the message has been acted upon is received.

5. The method of claim 1, wherein initiating the workflow further comprises presenting the message at a top of a message queue displayed within the messaging client of the recipient.

6. The method of claim 1, wherein the message is sent to a plurality of recipients, the method further comprising associating a plurality of workflows with the message, wherein different ones of the plurality of workflows are associated with different ones of the plurality of recipients.

7. The method of claim 1, further comprising implementing the organizational hierarchy as a lightweight directory access protocol directory.

8. The method of claim 1, further comprising implementing the organizational hierarchy as a directed acyclic graph.

9. The method of claim 1, further comprising a recipient of the message inheriting the workflow.

10. The method of claim 9, further comprising:
adding a requirement to the inherited workflow, thereby creating a modified workflow; and
initiating the modified workflow with respect to at least one other recipient according to an organizational relationship between the recipient and the at least one other recipient.

11. A system for modifying behavior of an electronic messaging system comprising:
an organizational hierarchy specifying user positions within an organization;
a messaging server comprising at least one workflow;
a first messaging client associated with a sender, wherein the first messaging client sends a message associated with the workflow to a recipient; and
a second messaging client associated with the recipient, wherein the workflow is initiated according to a position of the sender within the organizational hierarchy.

12. The system of claim 11, wherein a position within the organizational hierarchy of the recipient is identified, wherein the workflow is initiated according to an organizational relationship between the sender and the recipient.

13. The system of claim 12, wherein the workflow is selectively applied against the recipient according to the organizational relationship.

14. A computer program product comprising:
a computer-usable medium having computer-usable program code that modifies behavior of an electronic messaging system, said computer program product including:
computer-usable program code that receives a message from a sender;
computer-usable program code that determines that the message is associated with a workflow;
computer-usable program code that identifies a position of the sender within an organizational hierarchy; and
computer-usable program code that initiates the workflow associated with the message according to the position of the sender.

15. The computer program product of claim 14, further comprising computer-usable program code that identifies a position within the organizational hierarchy of a recipient of the message, wherein the computer-usable program code that initiates the workflow further comprises computer-usable program code that initiates the workflow according to an organizational relationship between the sender and the recipient.

16. The computer program product of claim 14, wherein the computer-usable program code that initiates the workflow further comprises computer-usable program code that selectively applies the workflow to at least one recipient of the message.

17. The computer program product of claim 14, wherein the message is sent to a plurality of recipients, the computer program product further comprising computer-usable program code that associates a plurality of workflows with the message, wherein different ones of the plurality of workflows are associated with different ones of the plurality of recipients.

18. The computer program product of claim 14, further comprising computer-usable program code that implements the organizational hierarchy as a directed acyclic graph.

19. The computer program product of claim 14, further comprising computer-usable program code that allows a recipient of the message to inherit the workflow.

20. The computer program product of claim 19, further comprising:
computer-usable program code that adds a requirement to the inherited workflow, thereby creating a modified workflow; and
computer-usable program code that initiates the modified workflow with respect to at least one other recipient according to an organizational relationship between the recipient and the at least one other recipient.
